(19) United States
(12) Patent Application Publication
(10) Pub. No.: US 2024/0275210 A1
(43) Pub. Date: Aug. 15, 2024

(54) HMD WITH CHARGING DEVICE

(71) Applicant: Apple Inc., Cupertino, CA (US)

(72) Inventors: Michael J. OUDENHOVEN, San Francisco, CA (US); Brian S. LAU, Sacramento, CA (US)

(21) Appl. No.: 18/644,001

(22) Filed: Apr. 23, 2024

Related U.S. Application Data
(63) Continuation of application No. PCT/US2022/076679, filed on Sep. 19, 2022.
(60) Provisional application No. 63/261,565, filed on Sep. 23, 2021.

(51) Int. Cl. H02J 50/10; G02B 27/01; H02J 7/00; H02J 7/34; H02J 50/80; H04R 1/02; H04R 1/10

(52) U.S. Cl. CPC H02J 50/10; G02B 27/0176; H02J 7/0063; H02J 7/342; H02J 50/80; H04R 1/028; H04R 1/1008; H04R 1/1025; H04R 1/1041; H04R 1/105; G02B 2027/0178; H04R 2499/15

(57) ABSTRACT

According to some aspects of the present disclosure, a wearable system can include a head-mounted display having a first battery and a first connector electrically coupled to the first battery. The system further including a wearable audio device having a second battery and a second connector electrically coupled to the second battery. The second connector configured to connect with the first connector to transfer power from the second battery to the first battery.

### CROSS-REFERENCE TO RELATED APPLICATION

This is a continuation of International Application No. PCT/US2022/076679, filed 19 Sep. 2022, entitled “HMD WITH CHARGING DEVICE,” claims priority to U.S. Provisional Patent Application No. 63/261,565, filed 23 Sep. 2021, entitled “CHARGING DEVICES,” the entire disclosure of which is hereby incorporated by reference.

### FIELD

The described embodiments relate generally to head-worn electronic devices. More particularly, the present embodiments relate to a head-mounted device that is charged using a wearable electronic device.

### BACKGROUND

A primary challenge when developing head-mounted displays, particularly head-mounted displays that have small form factors, is achieving a suitable battery life while still maintaining functionality and a socially acceptable shape and size. Performing the necessary computing functions, while still making the head-mounted display stylish and light enough that a user could wear the device for an extended period of time demands novel solutions not currently available.

Given the power consumption needs of head-mounted displays and current battery technology, a user may remove and charge the device several times a day, often interrupting use, and causing inconvenience to the user.

### SUMMARY

According to some aspects, a head-mounted device includes a display and a support attached to the display, the support including a charging portion including a conductor configured to receive power from a wearable device. The head-mounted device can further include a mechanical connector configured to physically attach the support to the wearable device. The head-mounted device can initiate a power transfer from the wearable device in response to the mechanical connector physically attaching the support to the wearable device.

In some examples, the head-mounted display includes a pair of computer glasses. The head-mounted device can include a switch to selectively initiate a power transfer from the wearable device to the head-mounted device. The support includes a first support arm and a second support arm, the first support arm including the charging portion and being in electrical communication with the second support arm.

In some examples, the support is a first support arm and the charging portion is a first charging portion. The head-mounted device can include a second support arm attached to the display, the second support arm having a second charging portion including a conductor configured to receive power from the wearable device. The charging portion can exchange data between the head-mounted device and the wearable device. The wearable device can include a head mounted audio device. The charging portion can include an inductive charger. The charging portion can include a direct electrical contact.

According to some aspects, a head-mounted audio device can include a support band, a speaker housing connected to the support band, a battery, and a charging portion including a conductor configured to transfer power from the battery to a head-mounted display. The head-mounted audio device can further include a magnetic connector configured to magnetically secure the head-mounted audio device to the head-mounted display.

In some examples, the head-mounted audio device can include a switch to selectively transfer power from the battery to the head-mounted display. The charging portion can include an inductive transmitting coil. The charging portion can include an electrical contact positioned on at least one of the support band or the speaker housing. The head-mounted audio device can further include a switch that initiates the transfer of power in response to the magnetic connector magnetically securing the head-mounted audio device to the head-mounted display.

According to some aspects of the present disclosure, a wearable system can include a head-mounted display having a first battery and a first connector electrically coupled to the first battery. The system further including a wearable audio device having a second battery and a second connector electrically coupled to the second battery. The second connector configured to magnetically connect with the first connector and to transfer power from the second battery to the first battery.

In some examples, the head-mounted display includes a pair of computer glasses including a first support arm, a second support arm positioned opposite the first support arm, and a processor housed within the at least one of the first support arm or the second support arm. The wearable audio device can include a pair of over-the-ear headphones including a first ear cup speaker, a second ear cup speaker, and a head band having a first end attached to the first ear cup speaker and a second end attached to the second ear cup speaker.

In some examples the head-mounted display further includes a switch that initiates the transfer of power from the second battery to the first battery in response to the connection of the second connector to the first connector. The head-mounted display and the wearable audio device can establish a compression fit connection. The first connector and the second connector can establish a direct electrical contact. The second connector can include a transmitting inductive coil configured to wirelessly connect with a receiving inductive coil of the first connector.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a block diagram of a head-mounted system.

FIG. 2A shows a top view of a head-mounted display.

FIG. 2B shows a front view of a wearable audio device.

FIG. 3A shows a side view of a head-mounted system.

FIG. 3B shows a cross-sectional side view of the head-mounted system.

FIG. 4 shows a side view of a head-mounted system.

FIG. 5A shows a side view of a head-mounted system.

FIG. 5B shows a side view of a head-mounted system.

FIG. 6A shows a cross-sectional view of a charging module.

FIG. 6B shows a cross-sectional view of a charging module.

FIG. 7 shows a top view of a head-mounted system in a charging case.

### DETAILED DESCRIPTION

Representative embodiments illustrated in the accompanying drawings are referenced in detail below. The following descriptions are not intended to limit the examples to one preferred embodiment. Rather, it is intended to cover alternatives, modifications, and equivalents as can be included within the spirit and scope of the described embodiments and the appended claims.

The following disclosure relates to a head-mounted display (HMD) system that includes a wearable device capable of transferring electrical power to another wearable device in the system. Traditional head-mounted displays face the inconvenience of frequent charging demands combined with the inconvenience of having to stop using and remove the head-mounted display to recharge. The head-mounted system described herein allows a device to be charged without requiring that the user remove or stop using the device. The head-mounted system can include a head-mounted display and a separate wearable device. In some examples, the head-mounted device includes a pair of computer glasses and the wearable device includes a pair of over-the-ear headphones. The wearable device can include an earbud speaker configured to be inserted into the user's ear. In some examples, the wearable device includes a battery pack configured to be supported over a head of a user. For example, one or more battery packs, or other power storage devices, can be attached to a support band that is designed to securely rest on, and be supported by, a user's head. In other words, the wearable device can be substantially similar to a pair of over-the-ear headphones, with the exception that the speakers or the over-the-head band are replaced with, or also include, batteries or other power storage devices and components for transferring the stored power to a head-mounted display. The head-mounted display can include a display portion (including one or more display modules) configured to be positioned in front of the user's eyes, and a support arm attached to the display portion and configured to support the head-mounted display on the user's head.

The head-mounted display can include two support arms attached to opposite sides of the display and configured to run along the sides of the user's head to rest over the ears during use. One or both of the support arms can include a charging module configured to receive power from the wearable device. The support arms can include additional electrical components, such as a battery, processors, circuitry, data communication modules, etc. In some examples, the charging module is configured to transfer power from the head-mounted display to the wearable device. In other words, the charging module can be bi-directional, capable of both receiving and transmitting an electrical charge. In some examples, the charging module includes an inductive charger capable of inductively charging and/or inductively being charged. An inductive charger, as used herein, can facilitate a power transfer when alternating current passes through an induction coil in the charging device, such as the headphones. The moving electric charge creates a magnetic field that in turn creates an alternating electric current in an induction coil of the receiving device (e.g., head-mounted display). The generated current can then pass through a rectifier to convert the current to direct current and charge the receiving device's battery. In another example, the charging module can include a direct electrical contact, such as a simple charger. In this manner, the wearable device can mate with and charge the head-mounted display without the need to remove the head-mounted display.

In some examples, the charging module can be configured to perform operations in addition to conducting a power transfer. For example, the system can include wired or wireless data communication protocols configured to exchange data between the head-mounted device and the wearable device. Using the data communication protocols, the head-mounted display and the wearable device (such as a head-mounted audio device) can be communicatively connected.

The head-mounted device can include a mechanical connector configured to physically attach the support arm to the wearable device. Likewise, the wearable device can include a mechanical connector configured to physically attach to the head-mounted device. Various mating attachment features can connect, attach, or couple the head-mounted device and the wearable device. A magnetic retention can be configured to magnetically attach the wearable audio device to the head-mounted device. Attachment features can include any form of mechanical, electrical, or magnetic attachment feature, system, or configuration, including but not limited to mechanical connectors such as fasteners, slots, snaps, clips, bindings, hook and loop fasteners, and straps; magnetic connectors including magnets, electro magnets, and magnetic pairs; and other similar engagement components configured to mate, attract, or frictionally engage a corresponding feature of the wearable audio device to retain and removably affix the head-mounted device to the wearable device. In some examples, the attachment features are absent, and the head-mounted device instead contacts or is in proximity with the wearable device in order to establish a physical and/or electrical connection.

In some examples, the wearable device can be referred to herein as a head-mounted audio device. The head-mounted audio device can include a support band to be placed over and rest on a top of the user's head. The head-mounted audio device can include a speaker housing connected to the support band. In some examples, the speaker housing is configured to be placed over, and deliver sound to, the user's ear. The head-mounted audio device can include two speaker housings joined via the support band. The speaker housings can be disposed on opposite ends of the support band to sandwich a user's head.

The head-mounted audio device can include a battery or other power storage devices. The battery can be located at a variety of locations on or in the head-mounted audio device. For example, the battery can be positioned within the speaker housing and/or within the support band. In some examples, the head-mounted audio device can include more than one battery (e.g., one battery disposed within each speaker housing). In some examples, the battery can be located on an external surface of the head-mounted audio device. The head-mounted audio device can include a charging module configured to transfer power from the battery to a head-mounted display, such as the head-mounted device discussed above. In some examples, the head-mounted display includes a pair of computer glasses, such as smart glasses. The charging module can be electrically connected to the battery.

In some examples, the charging module includes an electrical contact positioned on at least one of the support band or the speaker housing. The electrical contact can include an electrical terminal that is externally accessible. The head-mounted audio device can include a magnetic connector configured to magnetically secure the head-mounted audio device to the head-mounted display.

In some examples, a wearable system includes a head-mounted display (also referred to herein as a head-mounted device, HMD, computer glasses, and smart glasses) and a wearable audio device (also referred to herein as a wearable device, head-mounted audio device, headphones, and earbuds). The head-mounted display can include a first battery and a first connector electrically coupled to the first battery. The first battery can be located in a variety of locations including within a support arm or a frame of the head-mounted display. In some examples, the battery can be located on an external surface of the head-mounted display.

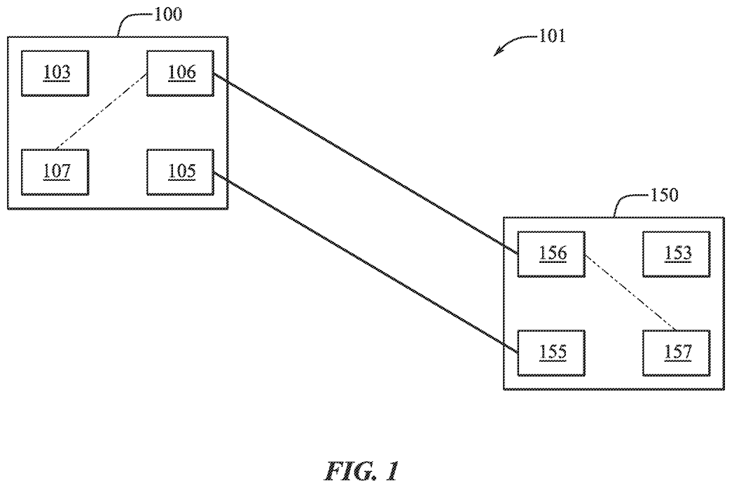

These and other embodiments are discussed below with reference to FIGS. 1-7. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a system 101 that includes a head-mounted display (HMD) 100 and a companion electronic device 150, such as a head-mounted audio device or headphones 150. While the following disclosure references “headphones 150” it will be understood that the device 150 can include a variety of electronic components and it not limited to headphones. The HMD 100 can include a processor 103, an attachment feature 105, an electrical connector 106, and a battery 107. Similarly, the headphones 150 can include a processor 153, an attachment feature 155, an electrical connector 156, and a battery 157. In some examples, the electrical connector 156 of the headphones 150 can establish an electrical connection with the electrical connector 106 of the HMD 100. The electrical connectors 106 and 156 can transfer power and/or data between the headphones 150 and the HMD 100.

In some examples, the power transfer occurs automatically upon establishing the electrical connection or contact between the HMD 100 and headphones 150. In some examples, the power transfer occurs in response to a user's command to initiate power transfer. For example, the HMD 100 and/or headphones 150 can include a switch, button, or other inputs that enables the user to manually initiate a power transfer between the HMD 100 and the headphones. In some examples, a power transfer occurs based on the relative charges in the respective batteries of the HMD 100 and headphones 150. For example, if the charge of the battery of the HMD 100 is above a predetermined threshold, a power transfer from the headphones 150 to the HMD 100 will not occur. However, once the battery of the HMD 100 drops below the threshold, a power transfer can automatically initiate. Likewise, if the battery of the headphones 150 is below a certain threshold, a power transfer from the headphones 150 to the HMD 100 may not occur.

In some examples, the attachment feature 105 of the HMD 100 can establish a physical attachment with the attachment feature 155 of the headphones 150. The attachment interface between the attachment features 105 and 155 can removably secure the HMD 100 to the headphones. The attachment features 105, 155 can be any form of mechanical, electrical, or magnetic attachment feature, system, or configuration, including but not limited to mechanical connectors such as fasteners, slots, snaps, clips, bindings, hook and loop fasteners, and straps; magnetic connectors including magnets, electro magnets, and magnetic pairs; and other similar engagement components configured to mate, attract, or frictionally engage a corresponding feature of the wearable audio device to retain and removably affix the HMD 100 and the headphones 150. In some examples, the attachment features 105, 155 are absent, and the HMD 100 instead contacts or is in close proximity with the headphones 150 in order to establish the connection between the electrical connectors 106, 156.

Power from the battery 157 of the headphones 150 can be transferred to the battery 107 of the HMD 100 via the electrical connectors 106, 156. This enables the HMD 100 to be charged without requiring the user to remove the HMD 100. Likewise, the processing or computing for the HMD 100 can be partially performed by the processor 153 in the headphones 150. Thus, the HMD 100 may, in some examples, include a smaller or less complex on-board processor, and instead, rely on the processor 153 in the headphones 150 when performing certain applications. Accordingly, in addition to exchanging power, the electrical connection established between the electrical connectors 106 and 156 can also selectively transfer data between the headphones 150 and the HMD 100.

The HMD 100 and the headphones 150 can exchange power using any appropriate wired or wireless protocol or configuration. In some examples, the electrical connectors 106 and 156 are direct electrical contacts configured to be in physical conductive contact with one another. In some examples, the electrical connectors 106 and 156 are inductive charging modules configured to inductively transfer power.

In some examples, the HMD 100 and the headphones 150 can wirelessly transfer data using any appropriate wired or wireless communications protocol (e.g. Bluetooth, Wi-Fi, cellular networks, radio, etc.). However, it will be understood that because the HMD 100 and the headphones 150 can be directly electrically connected, they are able to transfer data at much greater rates with less latency than a wireless communication. The components shown in FIG. 1 are non-exhaustive and non-limiting. The HMD 100 and the headphones 150 can include any number of additional sensors (e.g., cameras) and electrical components not explicitly shown in FIG. 1.

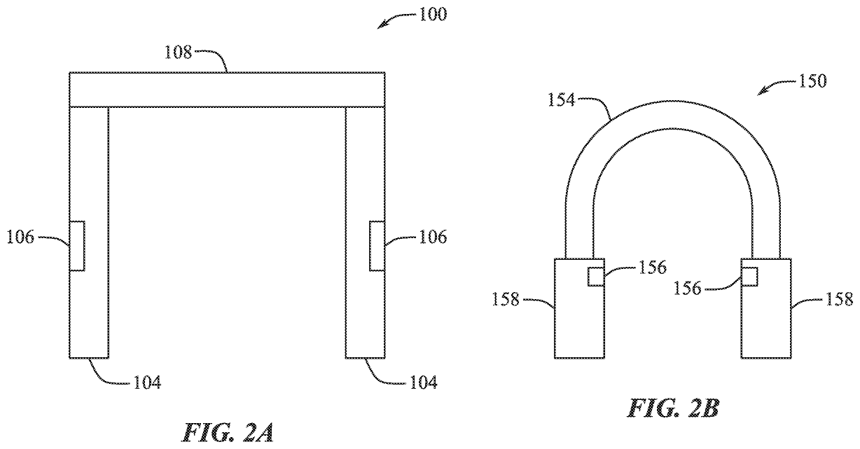

Any number or variety of components in any of the configurations described herein can be included in the headphones 150 and/or HMD 100. The components can include any combination of the features described herein and can be arranged in any of the various configurations described herein. The structure and arrangement of components can apply not only to the specific examples discussed herein, but to any number of examples in any combination. Various examples of the headphones 150 and HMD 100 are described below, with reference to FIGS. 2A-7.

FIG. 2A shows a top view of the HMD 100 (illustrated in FIG. 2A as computer glasses). While the embodiments depicted herein show computer glasses, it will be understood that the concepts detailed herein can apply to various head-mounted devices, and are not limited to “smart glasses.” The HMD 100 of FIG. 2A can be substantially similar to, including some or all of the features of, the HMDs described herein, such as HMD 100 of FIG. 1.

The HMD 100 can include a display element 108 that is positioned in front of the eyes of a user to provide information within a field of view of the user. The display element 108 can transmit light from a physical environment for viewing by the user. The display element 108 can include optical properties and elements, such as lenses for vision correction based on incoming light from the physical environment. Additionally or alternatively, the display element 108 can provide information as a display within a field of view of the user. The information can be provided to the exclusion of a view of a physical environment or in addition to (e.g., overlaid with) a physical environment.

In some examples, the HMD 100 include support arms 104 that support the HMD 100 on the user's head. The support arms 104 can be attached to, and can extend from, edges of the display element 108. In some examples, the support arms 104 can house internal computing components. For example, the support arms 104 can each enclose and support various integrated circuit chips, processors, memory devices, batteries, and other circuitry to provide computing and functional operations for the HMD 100.

The support arms 104 can wrap or extend along opposing sides of a user's head, such as a temple. The support arms 104 can include at least one charging module 106. As discussed in greater detail herein, the charging module 106 can include components to receive power from an external source to charge the battery of the HMD 100. As illustrated in FIG. 2A, the charging module 106 can be externally accessible to facilitate selective charging of the HMD during use.

In some examples, the support arms 104 further include attachment features (not shown) configured to removably attach the support arms to an external component, such as the headphones 150. The attachment features can be part of the charging modules 106, or can alternatively be a separate component. For example, the charging module 106 and the attachment features can be a unitary component that accomplishes both electrical and physical connections to the headphones 150. Further details of the headphones 150 are provided below with reference to FIG. 2B.

FIG. 2B illustrates a front view of headphones 150 according to one embodiment. The headphones 150 can be substantially similar to, including some or all of the features of, the headphones described herein, such as headphones 150 from FIG. 1. The headphones 150 can include speakers 158 and a support band 154. In some examples, the headphones 150 can include at least one charging module 156 (e.g., electrical connectors). The charging module 156 can be substantially similar to the charging modules 106. The charging module 156 can be incorporated into one or more of the speakers 158 and/or the support band 154. In some examples, the charging module 156 can include an attachment feature to physically attach the headphones 150 to an HMD (e.g., HMD 100). In some examples, the support band 154 includes an elasticity that biases the speaker 158 inward (i.e., toward the user's head) to squeeze or press the speaker 158 against the user's head. Additionally, the elasticity of the support band 154 can press the speakers 158 and/or support band 154 against the support arms 104. The pressure of the headphones 150 against the support arms 104 induced by the biasing of the speakers against the support arms can serve as an attachment feature. The charging module 156 can be externally accessible. While the charging module 156 is depicted on the ear cups or housing of the speakers 158, they can additionally or alternatively be formed on the support band 154.

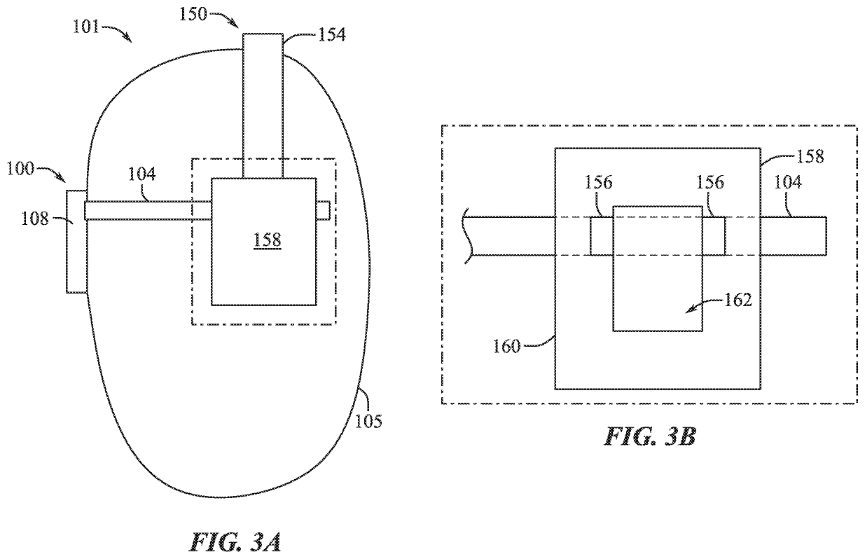

In the example of the HMD 100 including two support arms 104, each having a charging module 106, the headphones 150 can simultaneously transfer power to both of the charging modules 106. In some examples, the HMD 100 includes two batteries such that both batteries can be simultaneously charged by their respective charging modules 106. In some examples, a first of the support arms 104 can include a charging module 106, and a second of the support arms 104 can include electronics to establish a data communication link between the HMD 100 and the headphones 150. Alternatively, in one example, a single support arm 104 can include the charging module 106, and electrical conductors can be routed to the second support arm 104 to be simultaneously charged by the single charging module 106. Further details of an example head-mounted systems are provided below with reference to FIGS. 3A and 3B.

FIG. 3A illustrates a user 105 wearing a head-mounted system 101. The head-mounted system 101 of FIG. 3A can be substantially similar to, including some or all of the features of, the system 101 of FIG. 1. The head-mounted system 101 can include an HMD 100 and headphones 150. As illustrated, the head-mounted system 101 allows the HMD 100 to be charged without requiring the user 105 to remove the HMD 100. In some examples, the charging module 106 on the HMD 100 and the charging module 156 on the headphones 150 are positioned such that when a user 105 dons the HMD 100 and the headphones 150, the charging modules 106 and 156 are proximate enough to establish an electrical connection (either through direct electrical contact or inductive charging) to transfer power between the HMD 100 and the headphones 150. In some examples, the size and positioning of the charging modules 106 and 156 allow for the relative positioning of the HMD 100 and headphones 150 to vary while still enabling an electrical connection. In other words, the relative position of the HMD 100 and the headphones 150 can vary while maintaining an electrical connection. This can be a result of charging modules 106 that extend along a length of the support arms 104.

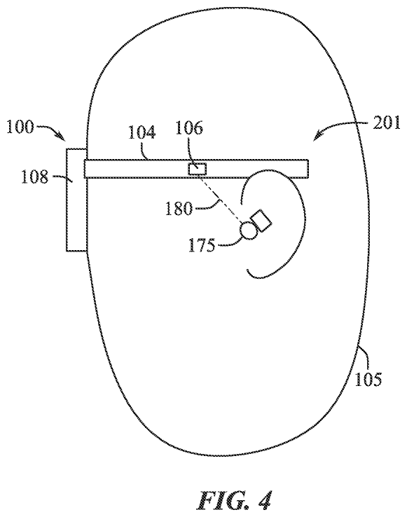

FIG. 3B illustrates a close-up side view of the head-mounted system 101. In some examples, the charging module 156 can include electrical terminals positioned on an inward facing side of a speaker 158 (i.e., toward the user 105). The speaker 158 can include a portion 160 that is configured to contact the user's head 105. The portion 160 can define a cavity or recess 162 configured to receive the user's ear. In some examples, the electrical terminals 156 are positioned on the inward facing side of the portion 160. In some examples, the electrical terminals 156 are positioned on opposite sides of the recess 162. The electrical terminals 156 can be positioned such that they contact a section of the support arm 104 that is adjacent or above the user's ear. In some examples, instead of speakers 156, the support band 154 can support battery packs or other power supplies that are designed to be positioned on either side of the user's head to charge the HMD 100. In some examples, the performance of the headphones 150 can be throttled or restricted to ensure adequate charging of the HMD 100. Similarly, the performance or functionality of the HMD 100 can be throttled or limited to ensure the headphones 150 maintain a sufficient charge. Further details of an example head-mounted systems are provided below with reference to FIG. 4.

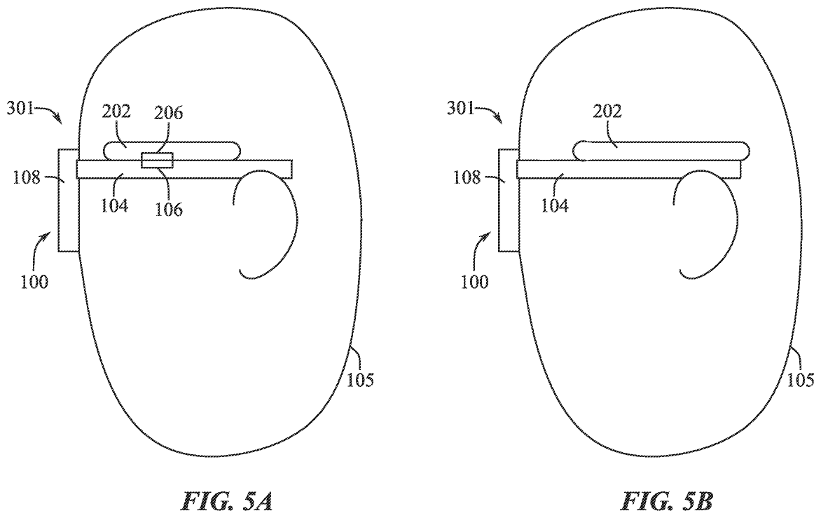

FIG. 4 illustrates a wearable system 201. The wearable system 201 can be substantially similar to, including some or all of the features of, the systems described herein, such as head-mounted system 101. The wearable system 201 can include the HMD 100 and earbuds 175. The earbuds 175 can be substantially similar to the headphones 150 with the exception that the earbuds 175 are not “over-the-ear” or “over-the-head” audio devices but are instead designed to be positioned at least partially within the user's ear. The earbuds 175 can establish a wireless connection 180 with the charging module 106 on the support arm 104. The wireless connection 180 can be an inductive connection to wirelessly transfer power between the earbuds 175 and the HMD 100. Any number of features, extensions, cables, or other components can be added to the earbuds 175 to facilitate continued use of both the HMD 100 and the earbuds 175 during charging. Further details of an example wearable systems are provided below with reference to FIGS. 5A and 5B.

FIG. 5A illustrates a wearable system 301 that includes an HMD 100 and an accessory device 202. The wearable system 301 can be substantially similar to, including some or all of the features of, the systems described herein, such as systems 101 and 201. The accessory device 202 can include a battery and a charging module 206 capable of transferring power to the HMD 100. In some examples, the accessory device 202 can be configured to attach to the HMD 100. The accessory device 202 can be positioned in a variety of positions and on a variety of surfaces of the HMD 100. For example, the accessory device 202 can be positioned on a top, bottom, or side surface of the support arm 104. In some examples, the accessory device 202 can be positioned on a frame of the HMD 100 or on the display 108 itself. In some examples, the accessory device 202 can be attached to the tip or end of the support arm 104.

The accessory device 202 can include a retaining feature 206. The retaining feature 206 can double as a charging module 206 to electrically couple with the charging module 106 of the HMD 100. In some examples, the accessory device 202 can be magnetically coupled with the support arm 104. The accessory device 202 can be configured to completely decouple, or detach, from the HMD 100 and be used to perform other functions, such as a stylus or other input device.

The support arm 104 can enclose and support several internal components (including a battery, integrated circuit chips and other circuitry) to provide computing operations for the HMD 100. In order to not interfere with the magnetic field generated by a magnet used to couple the accessory device 202, at least a portion of the support arm 104 near the magnet can be formed of any number of non-magnetic materials such as plastic or non-magnetic metal such as aluminum.

In some examples, the support arm 104 can include alignment structures to help ensure that the charging module 206 on the accessory device 202 is aligned with charging module 106. Examples of such alignment structures include magnetic alignment structures, indentations or grooves formed on the support arm 104, clip structures, protrusions, or any other desired alignment structure.

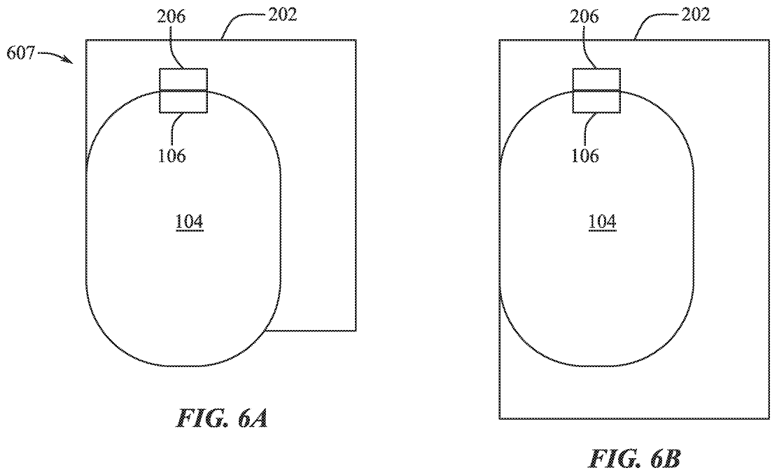

In some examples, the accessory device 202 can include additional functionality in addition to charging the HMD 100. As illustrated in FIG. 5B, the accessory device 202 can be a stylus or another input device. Further details of an example head-mounted systems are provided below with reference to FIGS. 6A and 6B.

FIG. 6A illustrates a cross-sectional view of the accessory device 202 attached to the support arm 104. As shown, the accessory device 202 can have a shape that assists in attaching the accessory device 202 to the support arm 104. For example, as shown in FIG. 6A, the accessory device 202 can be substantially “L” shaped, including a shelf or overhang 607. The overhang can be configured to at least partially surround or wrap around a top surface of the support arm 104 to allow the support arm 104 to hold the accessory device 202. The overhang 607 can curve around the support arm 104 such that the accessory device 202 is only removable by lifting the accessory device 202 upward from the support arm 104. As illustrated, the charging module 206 can be positioned on or within the accessory device 202 to align with the charging module 106 of the support arm 104 when the accessory device 202 is attached to the support arm 104. Although not depicted, in some examples, the accessory device can be a strap or band that connects to the support arm 104 and wraps around the back of the user's head.

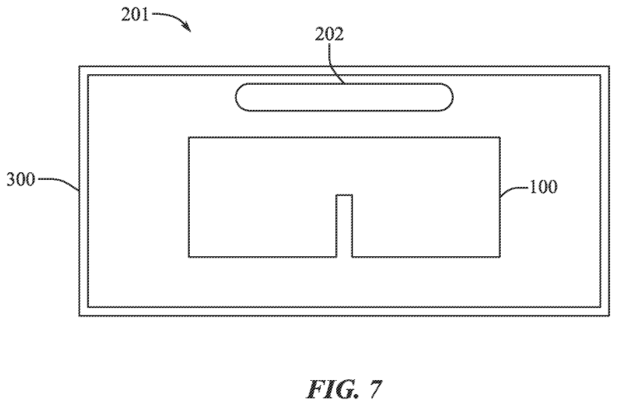

As shown in FIG. 6B, the accessory device 202 can be shaped to snap or slide onto the support arm 104. For example, the accessory device 202 can be substantially “C” shaped. The accessory device 202 can be shaped to surround a majority of a cross-section of the support arm 104. The accessory device 202 can include flexible material to allow the accessory device 202 to deform in order to snap, clip, or slide onto the support arm 104. Further, the charging module 206 can be positioned on or within the accessory device 202 to align with the charging module 106 of the support arm 104 when the accessory device 202 is attached to the support arm 104. In some examples, the accessory device 202 can be configured to be placed on a distal end of the support arm (i.e., opposite the proximal end of the support arm 104 that connects to the display 108). By positioning the accessory device 202 near the distal end of the support arm 104, the weight of the display 108 can be partially offset by the weight of the accessory device 202. In other words, the accessory device 202 can act as a counterbalance of the display 108. In some examples, the accessory device 202 can attached to an end or tip of the support arm 104 and can extend therefrom to form a retention feature or ear hook that partially wraps behind the user's ear and assists in preventing displacement of the HMD 100. Likewise, the accessory device 202, when attached to the support arm 104 can wrap behind the user's head to better secure the HMD 100 on the head of the user. Further details of example head-mounted systems are provided below with reference to FIG. 7.

FIG. 7 illustrates a top view of a wearable system 301 positioned in a charging case 300. The charging case can include electrical components capable of charging both the HMD 100 as well as the accessory device 202. The charging case 300 can include one or more modules for electrically coupling with one or more devices, such as the HMD 100 and the accessory device 202. In some examples, the HMD 100 and the accessory device 202 can be positioned in the same compartment of the charging case 300. In some examples, the charging case 300 includes multiple compartments and the HMD 100 and accessory device 202 are configured to be placed in individual charging compartments. In some examples, the accessory device 202 can be removable from the HMD 100 and can be charged separately in the charging case 300. In some examples, the accessory device 202 can be charged by the charging case 300 while still attached to the HMD 100. The charging case can include alignment or coupling components to ensure proper placement and securement of the HMD 100 and accessory device 202 within the charging case 300. In some examples, the HMD 100 can be communicatively coupled through a communications link with the charging case 300 via one or more electronic communication protocols. In some examples, the accessory device 202 has its own dedicated charging case.

The head-mounted devices described herein can be used with a wide variety of computer based reality. For example, computer-generated reality (CGR) environment refers to a wholly or partially simulated environment that people sense and/or interact with via an electronic system. The glasses can be used in a mixed reality environment. In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). Further, an augmented virtuality (AV) environment refers to a simulated environment in which a virtual or computer generated environment incorporates one or more sensory inputs from the physical environment.

In some examples, personal information data can be used to enhance the present exemplary systems and methods. Personal information data, when gathered using authorized and well established secure privacy policies and practices, can be used with the various embodiments described herein. However, the disclosed technology remains operable without such personal information data.

It will be understood that the details of the present systems and methods above can be combined in various combinations and with alternative components. The scope of the present systems and methods will be further understood by the following claims.

What is claimed is:

1. A head-mounted device, comprising:
a display;
a support attached to the display, the support comprising a charging portion including a conductor configured to receive power from a wearable device; and
a mechanical connector configured to physically attach the support to the wearable device;
wherein the head-mounted device initiates a power transfer from the wearable device in response to the mechanical connector physically attaching the support to the wearable device.

2. The head-mounted device of claim 1, wherein the head-mounted display comprises a pair of computer glasses.

3. The head-mounted device of claim 1, further comprising a switch to selectively initiate a power transfer from the wearable device to the head-mounted device.

4. The head-mounted device of claim 1, wherein the support comprises a first support arm and a second support arm, the first support arm comprising the charging portion and being in electrical communication with the second support arm.

5. The head-mounted device of claim 1, wherein:
the support is a first support arm; and
the charging portion is a first charging portion;
the head-mounted device further comprising:
a second support arm attached to the display, the second support arm comprising a second charging portion including a conductor configured to receive power from the wearable device.

6. The head-mounted device of claim 1, wherein the charging portion is configured to exchange data between the head-mounted device and the wearable device.

7. The head-mounted device of claim 1, wherein the wearable device comprises a head mounted audio device.

8. The head-mounted device of claim 1, wherein the charging portion comprises an inductive charger.

9. The head-mounted device of claim 1, wherein the charging portion comprises a direct electrical contact.

10. A head-mounted audio device comprising:
a support band;
a speaker housing connected to the support band;
a battery;
a charging portion including a conductor configured to transfer power from the battery to a head-mounted display; and
a magnetic connector configured to magnetically secure the head-mounted audio device to the head-mounted display.

11. The head-mounted audio device of claim 10, further comprising a switch to selectively transfer power from the battery to the head-mounted display.

12. The head-mounted audio device of claim 10, wherein the charging portion comprises an inductive transmitting coil.

13. The head-mounted audio device of claim 10, wherein the charging portion comprises an electrical contact positioned on at least one of the support band or the speaker housing.

14. The head-mounted audio device of claim 10, further comprising a switch that initiates the transfer of power in response to the magnetic connector magnetically securing the head-mounted audio device to the head-mounted display.

15. A wearable system, comprising:
a head-mounted display, comprising:
a first battery; and
a first connector electrically coupled to the first battery; and
a wearable audio device, comprising:
a second battery; and
a second connector electrically coupled to the second battery, the second connector configured to magnetically connect with the first connector and to transfer power from the second battery to the first battery.

16. The wearable system of claim 15, wherein:
the head-mounted display comprises a pair of computer glasses comprising:
a first support arm;
a second support arm positioned opposite the first support arm; and
a processor housed within the at least one of the first support arm or the second support arm; and
the wearable audio device comprises a pair of over-the-ear headphones comprising:
a first ear cup speaker;
a second ear cup speaker; and
a head band comprising a first end attached to the first ear cup speaker and a second end attached to the second ear cup speaker.

17. The wearable system of claim 15, further comprising a switch that initiates the transfer of power from the second battery to the first battery in response to the connection of the second connector to the first connector.

18. The wearable system of claim 15, wherein the head-mounted display and the wearable audio device are configured to establish a compression fit connection.

19. The wearable system of claim 15, wherein the first connector and the second connector establish a direct electrical contact.

20. The wearable system of claim 15, wherein the second connector comprises a transmitting inductive coil configured to wirelessly connect with a receiving inductive coil of the first connector.
